(19) United States
(12) Patent Application Publication
(10) Pub. No.: US 2013/0101836 A1
(43) Pub. Date: Apr. 25, 2013

(54) Coating for Converting Radiation Energy

(71) Applicants: Oral Cenk Aktas, Saarbruecken (DE); Michael Veith, St.-Ingbert (DE); Cagri Kaan Akkan, Saarbruecken (DE); Juseok Lee, Saarbruecken (DE); Marina Martinez Miró, Saarbruecken (DE)

(72) Inventors: Oral Cenk Aktas, Saarbruecken (DE); Michael Veith, St.-Ingbert (DE); Cagri Kaan Akkan, Saarbruecken (DE); Juseok Lee, Saarbruecken (DE); Marina Martinez Miró, Saarbruecken (DE)

(73) Assignee: Leibniz-Institut Fuer Neue Materialien gemeinnuetzige GmbH, Saarbruecken (DE)

(21) Appl. No.: 13/808,126

(22) PCT Filed: Jul. 8, 2011
(86) PCT No.: PCT/EP2011/061694

§ 371 Date: Jan. 3, 2013

(30) Foreign Application Priority Data
Jul. 13, 2010 (DE) 10 2010 027 063.6

(51) Int. Cl. C09D 1/00

(52) U.S. Cl. CPC C09D 1/00
USPC 428/336; 252/71; 106/286.5; 427/255.28; 126/714; 432/1

(57) ABSTRACT

A substrate comprises a coating for converting radiation energy into heat, the coating comprising a one-dimensional composite structure. The coatings can be used in particular as absorbers, for example for solar collectors.

### FIELD OF THE INVENTION

The invention relates to a substrate having a coating for converting radiation energy into heat, and to the use of said coating.

### PRIOR ART

The prior art discloses many energy-absorbing coatings. Energy-absorbing in this context is understood to mean the absorption of electromagnetic radiation, in particular of solar energy, and the conversion thereof into heat (photothermal conversion). This in particular relates to radiation in the range of the solar spectrum below a wavelength of 2 to 2.5 μm, in particular radiation in the range of the infrared of 1.0 μm to 2.5 μm.

Such coatings are generally colored black so that they have as broad an absorption as possible. At the same time they also have to have low reflection and intrinsic emission, however, so that occurring energy losses are as low as possible. Known coatings are, firstly, special varnishes or black-colored plastics. However, these usually have only a very low thermal conductivity.

Other coatings used are metallic coatings, such as black chromium coatings or black nickel coatings. However, these must be deposited using electroplating or chemical processes. In addition, they can be applied only to specific substrates.

In addition, composite materials which are used as absorption means are known. These are usually based on plasmon resonance of composite materials, usually materials with embedded nanoparticles. The optical properties of these materials can thus be controlled well. For example, it is possible for the absorption to be controlled by way of the layer thickness, particle concentration, particle size, particle appearance and orientation. These composite materials are usually obtained by embedding metallic nanoparticles in a ceramic matrix; these are known as cermets. If the metallic particles are smaller than the wavelength of the incident light, a very narrow absorption band is observed. The wavelength of the absorption maximum by the surface plasmon resonance (SPR) of the particles depends on the size and shape of the particles and also on the dielectric environment of the particles. In the case of a size distribution of particles, it is possible by superposition of the surface plasmon resonances for a broad absorption band to be formed. In this case, in particular non-spherical particles lead to formation of a plurality of surface plasmon resonances for a particle. With irregularly shaped particles, broad absorption bands can thus be formed. In the case of particles with two very different dimensions, for example rod-shaped particles, two distinct absorptions can be formed. One corresponds to the longitudinal plasmon resonance and one corresponds to the transverse plasmon resonance (plasmon splitting).

Owing to these effects, one-dimensional core/shell structures can also be of interest for such absorption effects, because these structures have at least two very different dimensions and thus have at least two different absorption bands. For example, specification U.S. Pat. No. 7,420,156 describes metallic nanowires as optical bandpass filters.

The structure uses the structure of the nanowires to control the absorption.

U.S. Pat. No. 7,603,003 also describes optical uses of nanowires.

The application DE 10 2006 013 484 A1 by the applicant describes the production of an element/element oxide composite material, that is to say a material containing at least one element and the corresponding element oxide. The application discloses such a composite material in the form of nanowires, which consist of a metal core enclosed by an oxide shell. These can be produced simply by chemical vapor deposition (CVD).

The one-dimensional composite structure can also be converted into oxide layers by irradiation using a laser. This is described in the application DE 10 2007 053 023 A1.

### Object

It is the object of the invention to produce a coated substrate which efficiently permits the conversion of radiation energy into heat. The intention is for many different materials to be able to be used as a substrate. The layers obtained should ensure high absorption even at a very low thickness.

### Solution

The object is achieved by the independent claims. Advantageous developments of the inventions are characterized in the subclaims. The wording of all claims is hereby included in the content of this description by reference. The invention also comprises all reasonable and in particular all mentioned combinations of independent and/or dependent claims.

The object is achieved by a substrate having a coating which comprises a one-dimensional composite structure.

A one-dimensional composite structure in this case is a composite comprising a metallic core and a metal oxide shell. The one-dimensional composite structure can comprise or consist of one or more nanowires of the construction described. In addition to these simple, linear, cable-like one-dimensional structures, the one-dimensional composite structure can alternatively or additionally comprise or consist of one or more branched structures constructed from a plurality of nanowires of the linear form that are grown on one another in a branched fashion. These two forms can also be referred to as linear and branched nanowires. In the case of the branched form, the metallic cores of the wires can touch one another at the branchings or the metal cores can be separated from one another by the metal oxide shell at the branchings. The one-dimensional composite structure is situated on the substrate and is part of the coating, preferably it is the only coating.

The nanowires have, in particular, two dimensions in the range below 200 nm, e.g. in the range of 1 to 200 nm and preferably 10 to 100 nm, in particular approximately 20 to 40 nm. The ratio of width to length of the nanowires is generally at least 1:3 and preferably at least 1:5. The third dimension is generally in the micrometer and submicron range. The cross section of the nanowires is generally approximately circular. The nanowires in the coating are here between 2 and 10 μm long.

The one-dimensional composite structure is composed of a metal and a metal oxide, with the metal being selected from the group containing Al, Ga, In or Tl, and the oxide is then the oxide of the corresponding metal. Preferably, a one-dimensional composite structure of aluminum and aluminum oxide (an Al/Al₂O₃ composite structure) is preferred.

The one-dimensional composite structure can contain small amounts of impurities, for example <2% carbon, for example as carbides such as an Al₄C₃. However, the one-dimensional composite structure is in particular free of residues of templates or catalysts.

Nanowires as are already known from DE 10 2006 013 848 A1 are preferred, explicit reference being made to the content of said specification.

It has now surprisingly been found that it is particularly advantageous if the one-dimensional composite structure in the coating has a thickness of less than 1 μm, preferably less than 500 nm. Irrespective of this, the thickness is greater than 50 nm, preferably greater than 100 nm, particularly preferably greater than 200 nm. The thickness can be between 100 nm and 1 μm, preferably between 200 nm and 500 nm, particularly preferably between 300 and 500 nm. The thickness of the coating results in this case from the orthogonal starting from the surface of the substrate. One-dimensional composite structures having a thickness in the stated ranges have a high absorption over a broad wavelength range even at low thickness and are at the same time significantly more resistant with respect to abrasion than layers with a greater thickness, because in the case of the latter the one-dimensional composite structure can detach.

The one-dimensional composite structure exhibits absorption over a broad wavelength range. This ranges from 240 nm to 3 μm. This also leads to the coated substrates being perceived as being black. In this case the coating is substantially composed of purely inorganic proportions, specifically the element and the corresponding element oxide. It is specifically because of the proportion of the element, preferably a metal such as aluminum, that the one-dimensional composite structure has very good thermal conductivity and is therefore able to very efficiently transfer the absorbed radiation onto the substrate.

The high inorganic proportion also ensures that the coating, as compared to coatings with organic absorption means, is stable up to high temperatures. For example, such coatings can be heated to over 400° C., without the absorption changing.

Different materials can be used for the substrates, for example metal, alloy, semiconductor, ceramic, quartz, glass or glass-like materials, preferably substrates are metals or alloys, such as aluminum, copper, stainless steel, iron, chrome-plated surfaces and glass or glass-like substrates. Preferred are thermally conductive substrates such as metals, alloys, such as aluminum, copper, stainless steel, iron and chrome-plated surfaces. In this case, a substrate can also be coated with a metallic layer.

The coating can also have further layers. It is preferred that the coating is substantially composed of the one-dimensional composite structure, preferably only of the one-dimensional composite structure.

The one-dimensional composite structure is preferably obtained using an MO-CVD method (metal organic chemical vapor deposition) which is described below.

Individual methods steps will be explained in more detail below. These steps need not necessarily be carried out in the order mentioned, and the method that will be explained can also have further steps which are not mentioned.

In order to produce the coating comprising a one-dimensional composite structure, metallo-organic precursors are converted into the vapor phase and thermolytically decomposed, the nonvolatile decomposition product generally depositing at or on the substrate. The precursors used in the invention have the general formula

El(OR)ₙH₂

wherein El denotes Al, Ga, In, Tl, Si, Ge, Sn, Pb or Zr, and R represents an aliphatic or alicyclic hydrocarbon radical, and n has the value 1 or 2 in dependence on the value of E1.

The aliphatic and alicyclic hydrocarbon radical is preferably saturated and has, for example, a length of 1 to carbon atoms. Alkyl or unsubstituted or alkyl-substituted cycloalkyl are preferred. The alkyl radical preferably has 2 to 15 carbon atoms, preferably 3 to 10 carbon atoms, and can be linear or branched, where branched alkyl radicals are preferred. Examples that may be mentioned here include: ethyl, n-propyl, n-butyl and the corresponding higher linear homologs, isopropyl, sec-butyl, neopentyl, neohexyl and the corresponding higher isoalkyl and neoalkyl homologs or 2-ethylhexyl. The alicyclic rings can comprise 1, 2 or more rings, each of which can be substituted by alkyl. The alicyclic radical preferably comprises 5 to 10, particularly preferably 5 to 8, carbon atoms. Examples that may be mentioned here include: cyclopentyl, cyclohexyl, methylcyclohexyl, norbonyl and adamantyl.

Oxide compounds which form ceramic oxides are preferably used according to the invention.

Particular preference is given to aluminum alkoxydihydrides having branched alkoxy radicals having 4 to 8 carbon atoms, in particular aluminum tert-butoxydihydride. The production of such compounds is described in DE 195 29 241 A1. They can be obtained for example by reacting aluminum hydride with the corresponding alcohol in a molar ratio of 1:1, wherein the aluminum hydride can be prepared in situ by reacting an alkali metal aluminum hydride with an aluminum halide. Furthermore, the production of such compounds is also described by Veith et al. (Chem. Ber. 1996, 129, 381-384), where it is also shown that the compounds of the formula El(OR)H₂ can also comprise dimeric forms, such as (El(OR)H₂)₂. (^{t}BuOAlH₂)₂ is particularly preferred.

The compounds are preferably converted into the vapor phase and thermolytically decomposed, the nonvolatile decomposition product generally being formed at or on a substrate in the form of the element/element oxide composite structure. Appropriate substrates for applying the coating include all customary materials which are inert with respect to the starting and end products. The thermolysis can be carried out e.g. in a furnace, at an inductively heated surface or at a surface situated on an inductively heated sample carrier. Only conductive substrates such as, for example, metals, alloy or graphite can be used in the case of inductive heating. In the case of substrates having a low conductivity, an electrically conductive substrate carrier or furnace should be used in the case of inductive heating. The heating can also be effected by microwaves of lasers. The substrate can therefore be either a surface of the reaction space or a substrate positioned therein. The reactor space used can have any desired configuration and consist of any customary inert material, for example Duran or quartz glass. Reactor spaces having hot or cold walls can be used. The heating can be effected electrically or by other means, preferably with the aid of a radiofrequency generator. The furnace and also the substrate carrier can have any desired forms and sizes corresponding to the type and form of the substrate to be coated; thus, the substrate can be for example a plate, plane surface, tubular, cylindrical, parallelepipedal or have a more complex form.

It may be advantageous to purge the reactor space a number of times with an inert gas, preferably nitrogen or argon, before the precursor is introduced. Moreover, it may be advantageous to apply an interim vacuum, if appropriate, in order to render the reactor space inert.

Furthermore, it may be advantageous, before the metallo-organic precursor is introduced, to heat the substrate to be coated, for example metal, alloy, semiconductor, ceramic, quartz, glass or glass-like material, to above 500° C. in order to clean the surface.

The desired element/element oxide composite structure preferably arises at temperatures of more than 400° C., particularly preferably more than 450° C. Preference is given to temperatures of not more than 1200° C., in particular not more than 600° C., e.g. from 400° C. to 1200° C., and preferably from 450° C. to 650° C., especially preferably 450° C. to 600° C., particularly preferably at 500 to 600° C. The substrate on or at which the thermolysis takes place is accordingly heated to the desired temperature. In this case, the production of the element/element oxide composite structure according to the invention is independent of the substrate material used and the constitution thereof.

The (metallo-organic) compound or the precursor can be introduced into the reactor from a supply vessel, which is preferably temperature-regulated to a desired evaporation temperature. Thus, it can be temperature-regulated for example to a temperature of between −50° C. and 120° C., preferably between −10° C. and 40° C. The thermolysis in the reactor space is generally effected at a reduced pressure of 10⁻⁶ mbar to atmospheric pressure, preferably in a range of 10⁻⁴ mbar to 10⁻¹ mbar, preferably 10⁻⁴ mbar to 10⁻² mbar, particularly preferably between 5×10⁻² mbar and 2×10⁻² mbar. In order to generate the vacuum, a vacuum pump system can be connected to the reactor on the outlet side. All customary vacuum pumps can be used; a combination of rotary vane pump and turbomolecular pump or a rotary vane pump is preferred. It is expedient for the supply vessel for the precursor to be fitted on the side of the reactor space and the vacuum pump system on the other side.

When the substrate is heated by induction, e.g. electrically conductive metal laminae or films having a size of one square centimeter can be arranged as substrate in a reaction tube composed of Duran or quartz glass. Upon adaptation of the dimensions of the apparatus, substrate areas in the range from square decimeters through to several square meters are likewise possible. The supply vessel with the precursor, temperature-regulated to the desired evaporation temperature, is connected to the reaction tube on the inlet side and a vacuum pump system is connected to said reaction tube on the outlet side. The reaction tube is situated in a radiofrequency induction field that is used to heat the substrate laminae or films to the desired temperature. After the desired pressure has been set and a precursor has been introduced, the substrate is covered with the element/element oxide composite structure.

It is advantageous to regulate the flow rate of the precursor using a valve. The valve can be controlled manually or automatically.

The morphology of the element/element oxide composite structure can be controlled by varying one or more process parameters selected from substrate temperature, gas pressure, precursor feed temperature, precursor flow (amount of precursor introduced per unit time) and vapor deposition time.

In order to obtain the composite structure according to the invention, the vapor deposition time for example at a temperature between 450° C. and 600° C. at a pressure between 1×10⁻² to 10×10⁻² mbar, preferably between 2×10⁻² to 5×10⁻² mbar, is up to 10 minutes.

Suitable substrates which can be used are various materials, for example metal, alloy, semiconductor, ceramic, quartz, glass or glass-like material, preferably substrates are metals or alloys, such as aluminum, copper, stainless steel, iron, chrome-plated surfaces and glass or glass-like substrates.

The structure, density and thickness of the one-dimensional composite structure can be controlled, as already described, for example by way of the duration of the thermal decomposition.

Thus, thermal decomposition of the precursor of only 1 to 5 minutes leads only to minor deposition of the one-dimensional composite structure on the substrate. A longer thermal decomposition leads to a denser deposition of the one-dimensional composite structure on the surface of the substrate. Thermal decomposition of up to 10 minutes leads to a one-dimensional composite structure having a thickness of 1 μm.

Advantageously, the method is carried out only until the one-dimensional composite structure has reached a thickness of a maximum of 1 μm. Preferably only until a thickness of less than 500 nm is reached, but at least until a thickness of 50 nm, preferably over 100 nm, particularly preferably over 200 nm is reached. In this manner, one-dimensional composite structures having a thickness of between 100 nm and 1 μm, preferably between 200 nm and 500 nm, particularly preferably between 300 and 500 nm, can be obtained.

The one-dimensional composite structure described above is particularly suitable as coating for applications in which the coated substrates are intended to be used to absorb radiation and to convert radiation into heat. This relates in particular to the absorption of sunlight, in this case in particular the infrared component being in the wavelength range of up to 2.5 μm, in particular between 1.0 μm and 2.5 μm.

It is particularly advantageous here that said one-dimensional composite structure can be applied easily on variously formed and metallic substrates.

These are in particular applications in the field of energy production from radiation, such as for example sunlight. These are in particular solar applications, this means applications which operate by absorbing sunlight. This can be solar collectors, solar panels, heat exchangers, heat storage means, cooling circuits, air conditioning systems, heat pumps, heating means for warm water or swimming pools.

The coatings can also be applied as filters on transparent surfaces and thus permit efficient filtering of the radiation. It is possible here by way of the structure of the composite structure to influence the absorption spectrum, in particular in the range of under 300 nm. The coating can also be applied in the form of a gradient. Furthermore, the coated substrates are also suitable as surfaces for SERS measurements (surface enhanced Raman spectroscopy). The dielectric structure of the nanowires leads to an intensification of the Raman signals.

This also relates to the use in building construction on surfaces of outer or inner walls, roofs or parts thereof, such as brickwork, roof tiles, roof slabs, tiling, wall claddings.

Further details and features will become apparent from the following description of preferred exemplary embodiments in conjunction with the dependent claims. In this case, the respective features can be realized by themselves or as a plurality in combination with one another. The possibilities for solving the problem are not restricted to the exemplary embodiments. Thus, by way of example, range indications always encompass all—unmentioned—intermediate values and all conceivable sub-intervals.

The exemplary embodiments are illustrated schematically in the figures. Same reference signs in the individual figures here relate to identical or functionally identical elements or to elements which correspond to one another with respect to their functions. The figures specifically show:

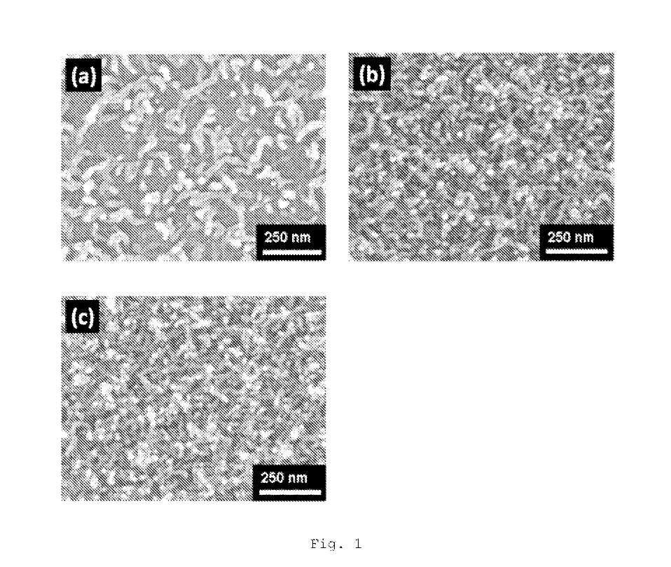

FIG. 1 shows SEM recordings (SEM: scanning electron microscope) of one-dimensional composite structures in (a) low, (b) medium and (c) high-density;

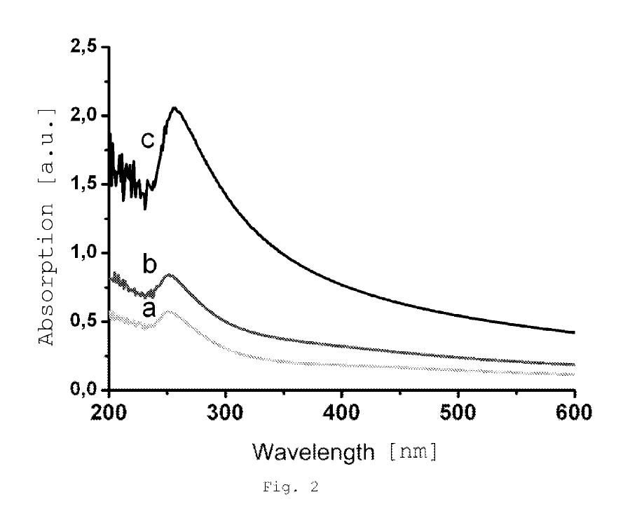

FIG. 2 shows absorption spectra of one-dimensional composite structures from FIG. 1 with (a) low, (b) medium and (c) high-density of nanowires;

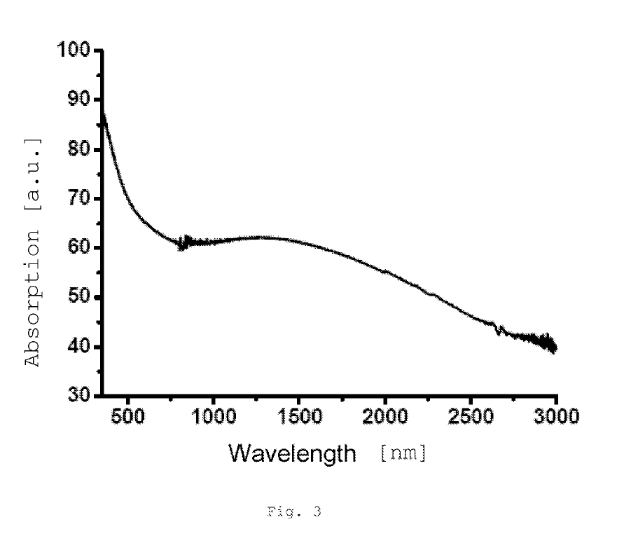

FIG. 3 shows an absorption spectrum of a one-dimensional composite structure having a thickness between 200 and 400 nm.

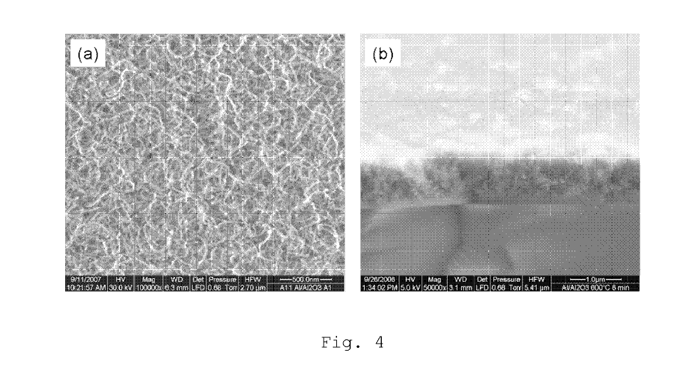

FIG. 4 shows SEM recordings of a one-dimensional composite structure in plan view (a) and in cross section (b).

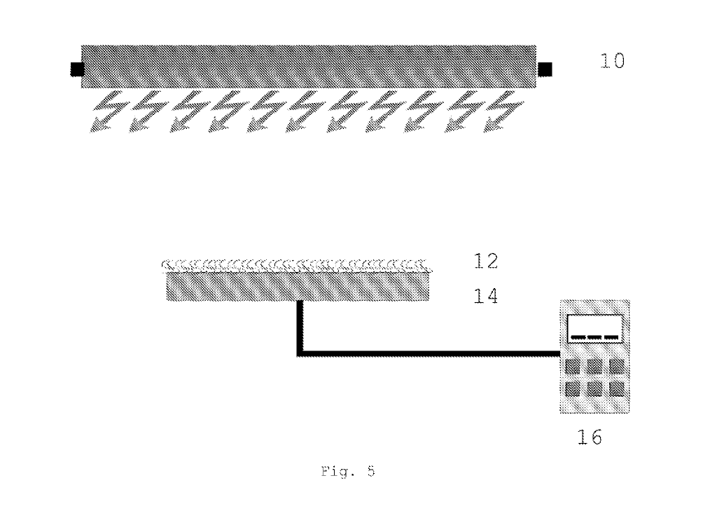

FIG. 5 shows a diagram of an arrangement for measuring the radiation-heat conversion;

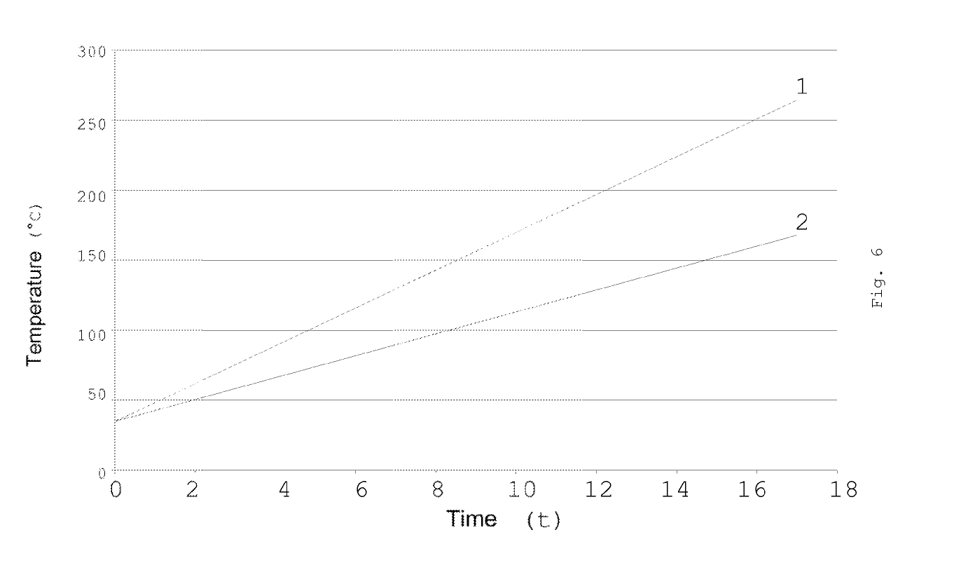

FIG. 6 shows a diagram of the measurement of the radiation-heat conversion.

FIG. 1 shows SEM recordings of different one-dimensional composite structures. These substantially differ in terms of their density on nanowires and also the thickness of the one-dimensional composite structure on the respective substrate. This is controllable by way of the duration of the thermal decomposition of the precursor on the substrate.

Thus, the coating with low density was obtained on nanowires by a short thermal decomposition time of under 1 minute. The sample with the medium density on nanowires was obtained by a decomposition time of 5 minutes. The sample having a high density on nanowires was obtained with a decomposition time of over 10 minutes.

Thus, the samples having a low-density have a thickness of 100 nm to 200 nm. The samples with medium density have a thickness of 200 nm to 300 nm. The samples with high-density have a thickness of up to 1 μm. Owing to the special structure of the one-dimensional composite structure, it is possible for coatings with high-density, i.e. having a thickness of up to 1 μm, preferably up to 500 nm, to also exhibit very good absorption and good transference of heat onto the substrate.

It can be seen in the figures that the nanowires are not in any order but grow chaotically on the substrate.

FIG. 2 shows absorption spectra of the samples from FIG. 1 in the UV/VIS range. Here, for the sample (a) with the low density, the plasmon resonance can be seen to be at 250 nm. With increasing density the resonance shifts to approximately 270 nm (sample b). With even higher density a shift to 280 nm can be observed. This indicates that with increasing growth of the nanowires the form of the absorbing metal centers changes. This effect can be used for example for optical filters. The position of the absorption band can be controlled in this case simply by way of the thickness.

FIG. 3 shows an absorption spectrum of a one-dimensional composite structure for the wavelength range between 500 nm and 3 μm on glass having a thickness between 300 to 500 nm.

FIG. 4 shows SEM recordings of a one-dimensional composite structure having a high-density in plan view (a) and in cross section (b). A thickness of less than 1 μm can be clearly seen.

FIG. 5 shows an experimental setup to determine the radiation-heat conversion. To this end a substrate (14), which is coated with a coating (12) according to the invention, is irradiated with a heat lamp (10). The temperature of the substrate is measured in the process using a measuring device (16). The change in temperature of the substrate over the course of the irradiation shows the radiation-heat conversion properties of the sample.

FIG. 6 shows a measurement of the radiation-heat conversion with an apparatus as shown in FIG. 5. To this end in an IR test station (Industrie ServIS GmbH; 5×((800 W) lamps (Heraeus); distance lamp-sample 80-100 mm; pyrometer: Maurer) was used.

As samples, two steel substrates (20 mm×20 mm×2 mm), once without coating and once coated, with a one-dimensional composite structure (Al/Al₂O₃ nanowires) having a density between 400 nm and 500 nm were used. After the coating, thermocouples (type K) were attached to the non-irradiated side of the substrate in order to measure, observe and record the temperature of the substrate during the experiments.

The experiments were carried out using a fast heating furnace having an IR lamp. The furnace controls the surface temperature of the sample with an online pyrometer, which controls the output of the IR lamps. During the test, the uncoated and coated substrates were placed in the furnace and the temperature was set to a specific value (175° C.) The connected pyrometer here controls the output of the IR lamps. Since both samples were placed next to one another in the oven, they were both exposed to the same intensity of IR radiation. In the process, both samples were connected with in each case one pyrometer. For the investigation, the pyrometer connected to the uncoated substrate was programmed to heat this sample to 175° C. within 15 seconds. Here, the temperature increase was measured on the respective rear side of the substrate. FIG. 6 shows the measured temperatures over time (in seconds). The curves show the coated substrate (1) and the uncoated substrate (2). The coated substrate in the same heating cycle becomes significantly warmer. This shows the significant improvement of the radiation-heat conversion by the one-dimensional composite structure.

Numerous modifications and developments of the described exemplary embodiments can be implemented.

### REFERENCE SIGNS

10 lamps

12 one-dimensional composite structure

14 substrate

16 pyrometer

### CITED LITERATURE

U.S. Pat. No. 7,420,156

U.S. Pat. No. 7,603,003

DE 10 2006 013 484 A1

DE 10 2007 053 023 A1

DE 195 29 241 A1

Veith et al. Chem. Ber. 1996, 129, 381-384

1. A coated substrate comprising a substrate having a coating for converting radiation energy into heat, wherein the coating comprises a one-dimensional composite structure.

2. The coated substrate as claimed in claim 1, wherein the one-dimensional composite structure has a thickness of less than 1 μm.

3. The coated substrate as claimed in claim 1, wherein the one-dimensional composite structure comprises an element/element oxide structure.

4. The coated substrate as claimed in claim 1, wherein the one-dimensional composite structure comprises an Al/Al₂O₃ composite structure.

5. (canceled)

6. A method for producing a coated substrate for converting radiation energy into heat, comprising:
thermal decomposition of a precursor of the formula
El(OR)ₙH₂,
wherein El comprises Al, Ga, In, Tl, Si, Ge, Sn, Pb or Zr, and R comprises an aliphatic or alicyclic hydrocarbon radical, and n has the value 1 or 2 in dependence on the value of El, on a substrate to form a one-dimensional composite structure,
wherein the decomposition is carried out until a layer thickness of the one-dimensional composite structure of under 1 μm is reached.

7. A method of absorbing radiation, comprising:
applying a one-dimensional composite structure to a substrate to obtain a coated substrate, wherein the substrate comprises to a solar collector, solar panel, heat exchanger, thermocouple, light protection coating, or optical filter;
absorbing radiation; and
converting the radiation into heat.

8. A solar collector comprising a coated substrate as claimed in claim 1.

9. A heat exchanger comprising a coated substrate as claimed in claim 1.

10. A thermocouple comprising a coated substrate as claimed in claim 1.

11. An optical filter comprising a coated substrate as claimed in claim 1 as a surface enhanced Raman spectroscopy substrate.
